(19) United States
(12) Patent Application Publication
(10) Pub. No.: US 2011/0036209 A1
(43) Pub. Date: Feb. 17, 2011

(54) POWER RATCHET HEAD

(75) Inventor: Chih-Ming Hung, Taichung (TW)

Correspondence Address: PAI PATENT & TRADEMARK LAW FIRM, 1001 FOURTH AVENUE, SUITE 3200, SEATTLE, WA, 98154, US

(73) Assignee: TRANMAX MACHINERY CO., LTD., Taiping City (TW)

(21) Appl. No.: 12/854,024

(22) Filed: Aug. 10, 2010

(30) Foreign Application Priority Data
Aug. 12, 2009 (TW) 98214832

(51) Int. Cl. B25B 13/46

(52) U.S. Cl. 81/60

(57) ABSTRACT

A power ratchet head is composed of a main body and a reinforcing rib. The main body is hollow inside and includes a pair of stopping portions, a receiving space, and a first through hole. The stopping portions are spaced from each other, extending outward from one end of the main body. The receiving space is formed between the two stopping portions. The first through hole runs through one of the stopping portions. The reinforcing rib is connected between the two stopping portions and located at free ends of the stopping portions, having a width that is smaller than the radius of the first through hole. The reinforcing rib is connected with the free ends of the stopping portions to structurally reinforce the main body, such that the stopping portions are not subject to outward deformation and the working life of the power ratchet head can be enhanced.

### BACKGROUND OF THE INVENTION

1. Field of the Invention The present invention relates generally to a ratchet powered by an air or the electricity, and more particularly, to a power ratchet head.

2. Description of the Related Art

A conventional power ratchet head 80 shown in FIG. 4 includes a main body 81, a ratchet assembly 82, and a protective cover 83. The main body 81 is hollow inside and has a pair of stopping portions 811 and a receiving space. The stopping portions 811 extend parallel from the main body 81 and formed in the same shape. The receiving space is located between the stopping portions 811. One of the stopping portions 811 has a through hole 813 for communication with the receiving space. The ratchet assembly 82 is mounted in the receiving space and has a protrusion 821 passing through the through hole 813 to be exposed outside the stopping portions 811. The protective cover 83 is mounted between the stopping portions 81.

However, when the power ratchet is operated, its power source can generate great power to violently vibrate the ratchet assembly 82 and the main body 81, such that the stopping portions 811 are subject to outward deformation at free ends for malfunction, as shown in FIG. 5, to need further improvement.

### SUMMARY OF THE INVENTION

The primary objective of the present invention is to provide a power ratchet head, which is not subject to deformation.

The foregoing objective of the present invention is attained by the power ratchet head composed of a main body and a reinforcing rib. The main body is hollow inside and includes a pair of stopping portions, a receiving space, and a first through hole. The two stopping portions are spaced from each other in a predetermined interval, extending outward from one end of the main body. The receiving space is formed between the two stopping portions. The first through hole runs through one of the stopping portions. The reinforcing rib is connected between the two stopping portions and located at free ends of the stopping portions, having a width that is smaller than the radius of the first through hole. The reinforcing rib and the stopping portions are connected in one piece.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is a sectional view of a part of the preferred embodiment of the present invention.

FIG. 4 is a perspective view of a conventional power ratchet head.

FIG. 5 is a perspective view of another conventional power ratchet head.

### DETAILED DESCRIPTION OF PREFERRED EMBODIMENTS

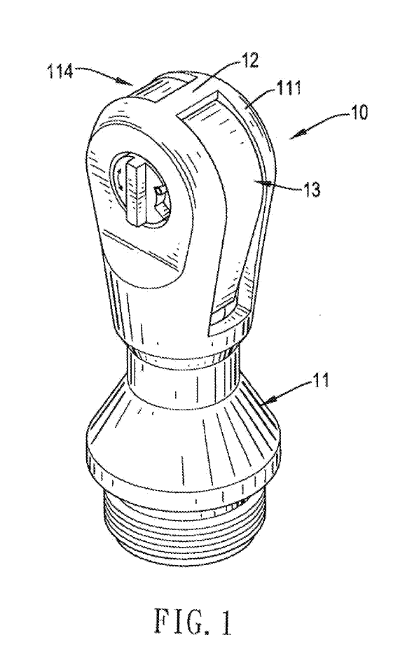

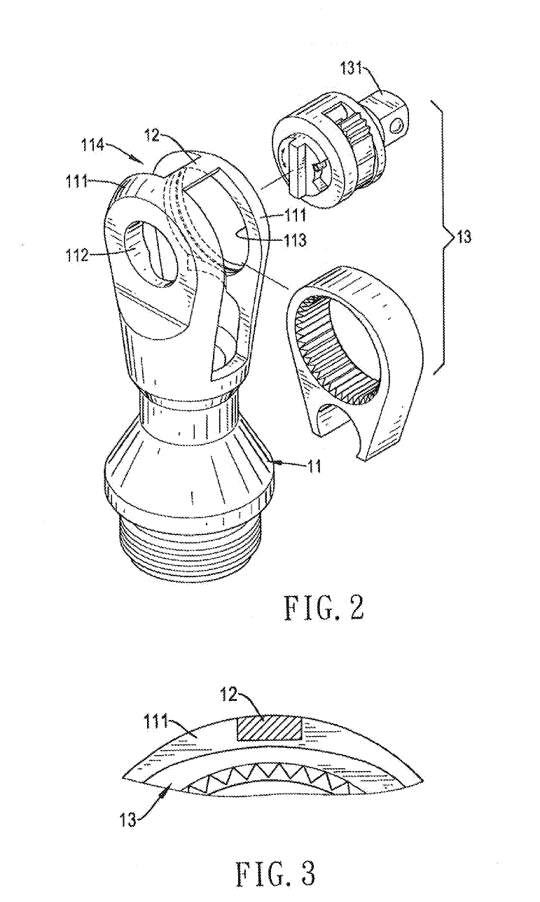

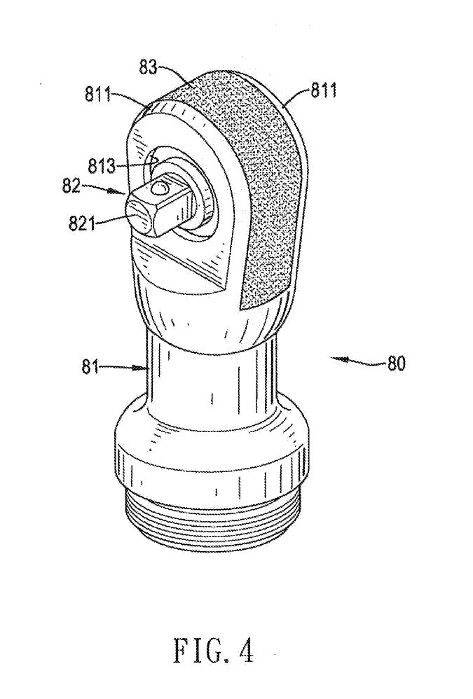

Referring to FIGS. 1-2, a power ratchet head 10 constructed according to a preferred embodiment of the present invention is composed of a main body 11, a reinforcing rib 12, and a ratchet assembly 13. The detailed descriptions and operations of these elements as well as their interrelations are recited in the respective paragraphs as follows.

The main body 11 is hollow inside and includes a pair of stopping portions 111, a first through hole 112, a second through hole 113, and a receiving space 114. The two stopping portions 111 extend parallel outward from one end of the main body 11, being spaced from each other for a predetermined interval and having the same shape. Each of the stopping portions 111 is arc-shaped at a free end thereof. The first through hole 112 runs through one of the stopping portions 111. The second through hole 113 runs through the other stopping portion 111 and is aligned with the first through hole 112. The diameter of the second through hole 113 is larger than that of the first through hole 112. The receiving space 114 is located between the stopping portions 111.

Referring to FIGS. 2-3, the reinforcing rib 12 is flat and bar-like and connected between midsections of the free ends of the stopping portions 111. The reinforcing rib 12 defines a width which is the distance between two opposite sides thereof rather than the other two opposite sides connected with the stopping portions separately. The width of the reinforcing rib 12 is smaller than the radius of the first through hole 112. Because the reinforcing rib 12 is not big and can prevent the ratchet assembly 13 from interference with the reinforcing rib 12 and from failing to be installed in the main body 11 through the receiving space 114, a user can install the ratchet assembly 13 conveniently.

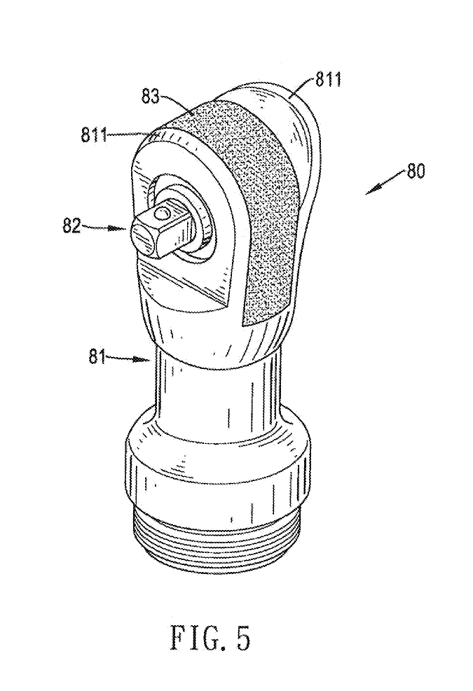

Preferably, the reinforcing rib 12 is connected with each of the stopping portions 111 in one piece. Because the reinforcing rib 12 is connected with the free ends of the stopping portions 111, the main body 11 can be structurally reinforced to prevent the stopping portions 111 from outward deformation to prolong the working life of the power ratchet head 10. Therefore, the present invention is apparently better than the prior art as that shown in FIG. 5.

As shown in FIG. 2, the ratchet assembly 13 can be rotatably mounted to the receiving space 114 and includes a protrusion 131 protruding therefrom through the second through hole 113 to be exposed outside the main body 11. As for the detailed structure and actions of the ratchet assembly 13, they belong to the prior art and are not the key points of the present invention, such that they are omitted.

In conclusion, the present invention includes the following advantages and effects.

1. The reinforcing rib is connected with the free ends of the stopping portions to structurally reinforce the main body, such that the stopping portions are not subject to outward deformation and the working life of the power ratchet head can be enhanced.

2. Since the width of the reinforcing rib is smaller than the radius of the first through hole, it prevents the ratchet assembly from interference with the reinforcing rib and allows the user to install the ratchet assembly in the main body conveniently.

Although the present invention has been described with respect to a specific preferred embodiment thereof, it is in no way limited to the specifics of the illustrated structures but changes and modifications may be made within the scope of the appended claims.

What is claimed is:

1. A power ratchet head comprising:
a hollow main body having a pair of stopping portions extending outward from an end thereof and spaced from each other, a receiving space formed between the stopping portions, and a through hole running through one of the stopping portions; and
a reinforcing rib connected with midsections of free ends of the stopping portions and having a width smaller than a radius of the first through hole.

2. The power ratchet head as defined in claim 1, wherein the reinforcing rib is connected with the stopping portions in one piece.
